(19) United States
(12) Patent Application Publication
(10) Pub. No.: US 2011/0039472 A1
(43) Pub. Date: Feb. 17, 2011

(54) METHOD OF MANUFACTURING A LAMP

(76) Inventors: SANGHYUCK YOON, Seoul (KR); So jin Ryu, Seoul (KR); Byungchoon Yang, Seoul (KR); Myeong-Ju Shin, Seoul (KR); Jae-Wook Lee, Seoul (KR); Hyuck-Soo Song, Seoul (KR); Min-Kyu Lee, Yongin-si (KR); Se-Hoon Jeong, Cheongwon-gun (KR)

Correspondence Address: F. CHAU & ASSOCIATES, LLC, 130 WOODBURY ROAD, WOODBURY, NY, 11797, US

(21) Appl. No.: 12/847,294

(22) Filed: Jul. 30, 2010

(30) Foreign Application Priority Data
Aug. 14, 2009 (KR) 10-2009-0075273

(51) Int. Cl. H01J 9/02

(52) U.S. Cl. 445/26

(57) ABSTRACT

Disclosed is a method of manufacturing a lamp. The lamp is formed by arranging lamp electrodes in a lamp body provided therein with a discharge space and a fluorescent material. A first conductive layer is formed on a base conductor and a second conductive layer is formed on the first conductive layer by allowing the first conductive layer to react with a reaction solution including a solvent and metallic salt, thereby forming the lamp electrodes.

### CROSS-REFERENCE TO RELATED APPLICATION

This application claims priority from Korean Patent Application No. 10-2009-0075273 filed on Aug. 14, 2009, the contents of which are hereby incorporated by reference herein in their entirety.

### BACKGROUND

1. Technical Field of the Invention The present disclosure relates to a method of manufacturing a lamp. More particularly, the present disclosure relates to a method of manufacturing a lamp, capable of improving luminous efficiency while ensuring long life span of the lamp.

2. Description of the Related Art

In general, a liquid crystal display (LCD) includes an LCD panel and a backlight assembly that supplies light to the LCD panel. The backlight assembly may include a plurality of fluorescent lamps as light sources.

The fluorescent lamps of the backlight assembly may consume a significant amount of power in the LCD. For instance, power consumption of the fluorescent lamps may be about roughly 90% or above with respect to total power consumption of the LCD.

### SUMMARY

An exemplary amount of the present invention provides a method of manufacturing a lamp, capable of improving luminous efficiency while ensuring long life span of the lamp.

According to an exemplary embodiment of the present invention, the lamp is manufactured through the following processes. A lamp body provided therein with a discharge space and a fluorescent material is prepared. Lamp electrodes, which emit electrons toward the discharge space by using voltage supplied externally, are formed. Then, the lamp electrodes are arranged in the lamp body.

The lamp electrodes are formed through the following processes. A base conductor is formed and a first conductive layer is formed on the base conductor. Then, a second conductive layer is formed on the first conductive layer by allowing the first conductive layer to react with a reaction solution including a solvent and metallic salt.

The solvent includes one of alcohol including R—OH, ether including R—O—R′, benzene, benzene derivatives, and a carboxylic acid including R—COOH.

According to the above, water is not generated in the lamp body during the manufacturing process for the lamp, so that the luminous function of the lamp can be improved. In addition, the amount of electrons emitted from the lamp electrode may be increased due to coating layers formed on a surface of the base conductor constituting the lamp electrode, so that luminous efficiency of the lamp can be improved. Further, the base conductor can be protected from electrons or ions due to the coating layers, so that the life span of the lamp may be extended.

In accordance with another exemplary embodiment of the present invention, a method of manufacturing a lamp is provided. The method includes forming a lamp body which includes a glass tube having a discharge space therein and fluorescent members provided on an inner wall of the lamp body, foaming lamp electrodes for arranging in the lamp body. The forming of each of the lamp electrodes includes forming a base conductor, depositing a first conductive layer having a thickness of about 1 μm to about 6 μm on the base conductor through one of E-beam evaporation, ion plating and sputtering, wherein the first conductive layer includes a metal having a high melting point such that the first conductive layer is not deformed by heat generated during operation of the lamp and has a low work function and immersing the base conductor with the first conductive layer formed thereon in a reaction solution comprising a solvent and a metallic salt, thereby reacting the first conductive layer with the reaction solution to form a second conductive layer on the first conductive layer. The second conductive layer includes one of beryllium (Be), magnesium (Mg), calcium (Ca), strontium (St), barium (Ba), cesium (Cs), and radium (Ra), and the solvent includes one of an alcohol comprising R—OH, an ether comprising R—O—R′, benzene, benzene derivatives, and a carboxylic acid, in which the R and R′ are alkyl groups having a carbon number of 15 or less. In addition, the method further includes removing the solvent by subjecting the base conductor, the first conductive layer and the second conductive layer to a heat treatment performed at a temperature of about 100° C. to about 400° C., thereby forming the lamp electrode.

The method further includes arranging the lamp electrodes in the lamp body in the vicinity of both ends of the lamp body and filling in the lamp body with a reaction gas and sealing the lamp body, thereby completing the fabrication of the lamp. Moreover, the lamp electrodes are electrically connected to lead terminals of the lamp such that power supplied externally is transferred to the lamp electrodes through the lead terminals, so that the lamp may emit light.

### BRIEF DESCRIPTION OF THE DRAWINGS

Exemplary embodiments of the present invention can be readily understood by reference to the following detailed description when considered in conjunction with the accompanying drawings wherein:

FIG. 1 is a perspective view showing a lamp according to an exemplary embodiment of the present invention;

FIG. 2 is a sectional view taken along line I-I′ of FIG. 2;

FIG. 3 is a block view showing a manufacturing procedure for a lamp according to an exemplary embodiment of the present invention;

FIGS. 4A and 4B are perspective views showing a lamp electrode being manufactured;

FIG. 4C is a perspective views showing a lamp electrode that has been manufactured;

FIG. 5 is a view showing a process of forming a second conductive layer on a first conductive layer;

FIG. 6 is a table showing start time of a lamp when a second conductive layer is applied to a lamp electrode or not;

FIG. 7 is a graph showing start voltage of a lamp when a first conductive layer is applied to a lamp electrode or not;

FIG. 8 is a graph showing lamp voltage as a function of lamp current when a first conductive layer is applied to a lamp electrode or not;

FIG. 9 is a graph showing the temperature of a lamp electrode part as a function of lamp current when a first conductive layer is applied to a lamp electrode or not;

FIG. 10 is a graph showing lamp efficiency as a function of lamp current when a first conductive layer is applied to a lamp electrode or not; and

FIG. 11 is a graph showing a brightness maintenance rate as a function of accelerated life when a first conductive layer is applied to a lamp electrode or not.

### DESCRIPTION OF THE EXEMPLARY EMBODIMENTS

Hereinafter, exemplary embodiments of the present invention will be described in detail with reference to accompanying drawings. However, the present invention is not limited to the following embodiments but includes various applications and modifications. The following embodiments are provided to clarify the technical spirit disclosed in the present invention and to sufficiently transmit the technical spirit of the present invention to the one having mean knowledge and skill in this field. Therefore, the scope of the present invention should not be limited to the following embodiments.

In addition, the size of the layers and regions of the attached drawings along with the following embodiments are simplified or exaggerated for precise explanation or emphasis and the same reference numeral represents the same component.

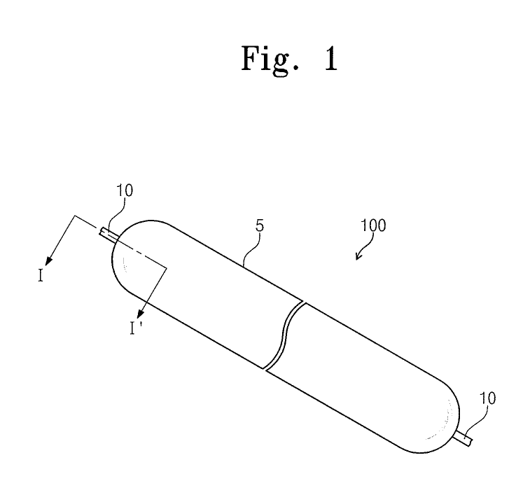

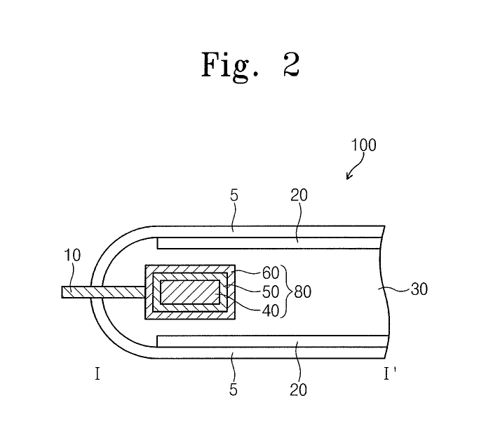

FIG. 1 is a perspective view showing a lamp according to an exemplary embodiment of the present invention, and FIG. 2 is a sectional view taken along line I-I′ of FIG. 2.

Referring to FIGS. 1 and 2, a lamp 100 includes a lamp body 5, lamp electrodes 80, reaction gas 30, fluorescent members 20 and lead terminals 10.

In the present exemplary embodiment, the lamp 100 may include, for example, a cold cathode fluorescent lamp (CCFL) having a tubular shape extending in one direction.

The lamp body 5 may include a glass tube having a discharge space therein. The lamp electrodes 80 are accommodated in the lamp body 5 in the vicinity of both ends of the lamp body 5. The lamp electrodes 80 are electrically connected to the lead terminals 10, respectively. Thus, power supplied from the outside is transferred to the lamp electrodes 80 through the lead terminals 10, so that the lamp 100 may emit light.

The discharge space is filled with the reaction gas 30. The reaction gas 30 may include inert gas, such as, for example, mercury (Hg), neon (Ne), krypton (Kr), argon (Ar), or xenon (Xe). In addition, the fluorescent members 20 are provided on an inner wall of the lamp body 5.

In the lamp 100 having the above elements, if an external power is supplied to the lamp electrodes 80 through the lead terminals 10, a potential difference may be generated between the lamp electrodes 80 provided at both sides of the lamp body 5, so that the lamp electrode 80 emits electrons. The electrons are absorbed in atoms of the reaction gas 30, so that the atoms may have higher energy. Then, the atoms having the higher energy emit absorbed energy as ultraviolet ray such that the atoms can be stabilized. The ultraviolet ray may be converted into visible ray by the fluorescent members 20 and then is emitted to the outside through the lamp body 5.

Meanwhile, the lamp electrode 80 may include a base conductor 40, a first conductive layer 50 formed on the base conductor 40 while surrounding the base conductor 40, and a second conductive layer 60 formed on the first conductive layer 50 while surrounding the first conductive layer 50. That is, the first and second conductive layers 50 and 60 are sequentially coated on the base conductor 40 of the lamp electrode 80.

In the present exemplary embodiment, the base conductor 40 may have, for example, a cylindrical shape. The base conductor 40 may include, for example, nickel (Ni), molybdenum (Mo), niobium (Nb), tantalum (Ta), titanium (Ti), vanadium (V), chrome (Cr), gold (Au), copper (Cu) or aluminum (Al). In addition, the base conductor 40 may include an alloy having at least two of the above elements.

The first conductive layer 50 is formed on the base conductor 40. The first conductive layer 50 may include metal having a high melting point such that the first conductive layer 50 is not deformed by heat generated during the operation of the lamp 100. In addition, the first conductive layer 50 may include, for example, a metal or metal oxide having a low work function such that the amount of electrons emitted through the base conductor 40 and the first conductive layer 50 increases.

The first conductive layer 50 may include, for example, one selected from the group consisting of beryllium (Be), magnesium (Mg), calcium (Ca), strontium (St), barium (Ba), cesium (Cs), and radium (Ra). The first conductive layer 50 may include an oxide including one of the above elements, such as, for example, magnesium oxide (MgO).

The second conductive layer 60 is formed on the first conducive layer 50. The second conductive layer 60 may include one selected from the group consisting of, for example, beryllium (Be), magnesium (Mg), calcium (Ca), strontium (St), barium (Ba), cesium (Cs), and radium (Ra). The second conductive layer 60 may include an oxide including one of the above elements, such as, for example, cesium oxide (Cs₂O₃).

The second conductive layer 60 can shorten a start time of the lamp 100. For example, when a drive time is defined as a time between a time point of supplying power to the lamp 100 and a time point of generating the visible ray from the lamp 100, if the lamp 100 is located in a dark place for a long time without applying the second conductive layer 60 to the lamp electrode 80, electrons in the lamp 100 may be extinguished, so that the start time may be lengthened.

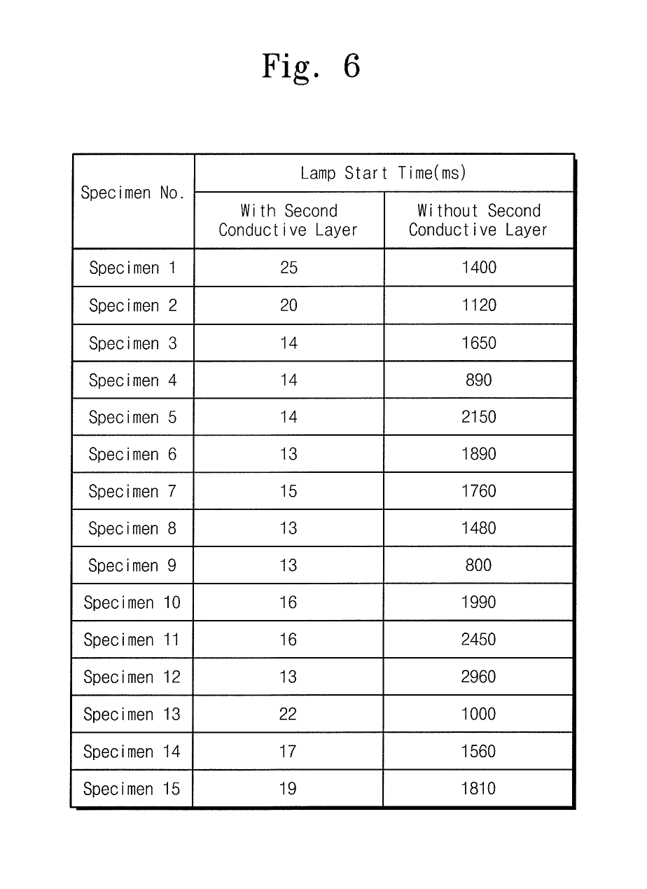

However, according to the present exemplary embodiment of the present invention, the second conductive layer 60 is applied to the lamp electrode 80, so that the start time of the lamp can be shortened. A test result is shown in FIG. 6 as evidence of the above.

FIG. 6 is a table showing the start time of the lamp 100 when the second conductive layer is applied to the lamp electrode 80 or not.

Referring to FIGS. 2 and 6, the start time of the lamp 100 is measured with respect to 15 specimens by applying the second conductive layer 60 to the lamp electrode 80 or not. For example when the lamp electrode 80 includes the second conductive layer 60, the start time of the lamp 100 ranges from about 13 ms to about 25 ms, and the average value is about 16 ms. In contrast, when the lamp electrode 80 does not include the second conductive layer 60, the start time of the lamp 100 ranges from, for example, about 800 ms to about 2960 ms, and the average value is about 1600 ms. In general, the standard start time of the lamp is about 500 ms. As the lamp 100 is mainly used as a light source of the LCD, the second conductive layer 60 may be a beneficial element for the lamp electrode 80.

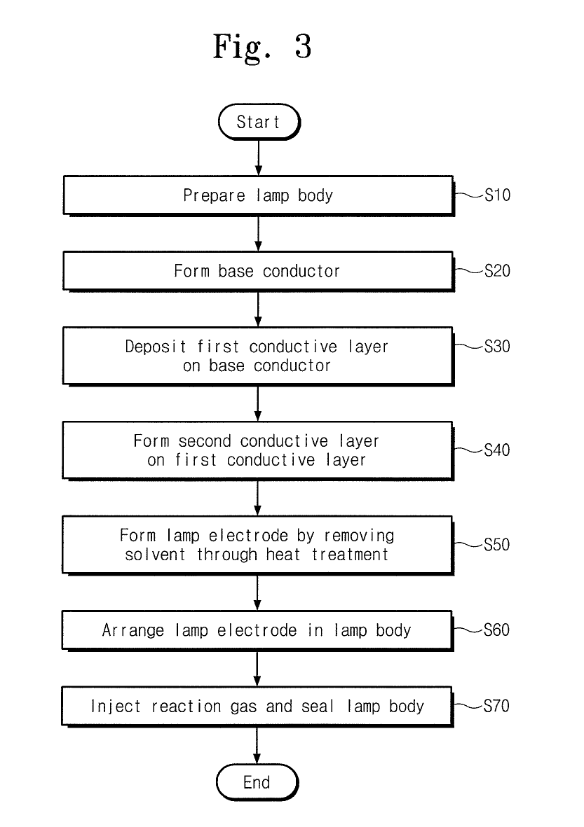

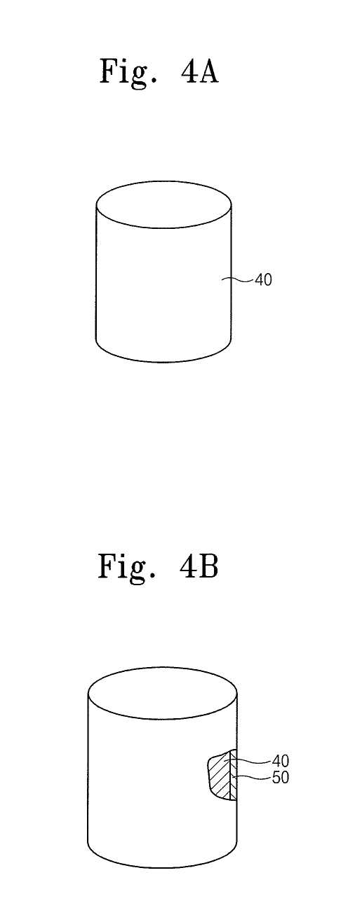

FIG. 3 is a block view showing a manufacturing procedure for the lamp 100 according to an exemplary embodiment of the present invention, FIGS. 4A and 4B are perspective views showing the lamp electrode 100 being manufactured, and FIG. 4C is a perspective views showing the lamp electrode 100 that has been manufactured.

Referring to FIGS. 2, 3 and 4A, the lamp 100 is manufactured through the following processes. First, the lamp body 5 is prepared (S10). As mentioned above with reference to FIG. 2, the lamp body 5 is a thin glass tube and the fluorescent lamps 20 are formed on the inner wall of the lamp body 5.

Then, the base conductor 40 is formed (S20). The base conductor 40 may be fabricated in a cylindrical structure by processing raw material including, for example, nickel (Ni), molybdenum (Mo), niobium (Nb), tantalum (Ta), titanium (Ti), vanadium (V), chrome (Cr), gold (Au), copper (Cu), aluminum (Al), or an alloy including at least one of the above elements.

After that, the first conductive layer 50 is formed on the base conductor 40 (S30). In the present exemplary embodiment, the first conductive layer 50 is deposited on the base conductor 40 through one of E-beam evaporation, ion plating and sputtering. The first conductive layer 50 formed on the base conductor 40 may have a thickness of, for example, about 1 μm to about 6 μm.

When the first conductive layer 50 is formed on the base conductor 40 through the E-beam evaporation, a target metal and the base conductor 40 are loaded in a chamber of an E-beam evaporator such that the target metal faces the base conductor 40, and an E-beam is irradiated onto the target metal such that metal particles are generated from the target metal, thereby depositing the metal particles on the base conductor 40.

Meanwhile, the experimental result shows that the first conductive layer 50 may be deposited on the base conductor 40 with uniform thickness and improved strength if the deposition direction of the metal particles, which are deposited on the base conductor 40 in the chamber of the E-beam evaporator, is slightly tilted at an angle of about 45° or below. In addition, the first conductive layer 50 including metal oxide may be formed on the base conductor 40 by performing, for example, E-beam evaporation in the oxygen atmosphere.

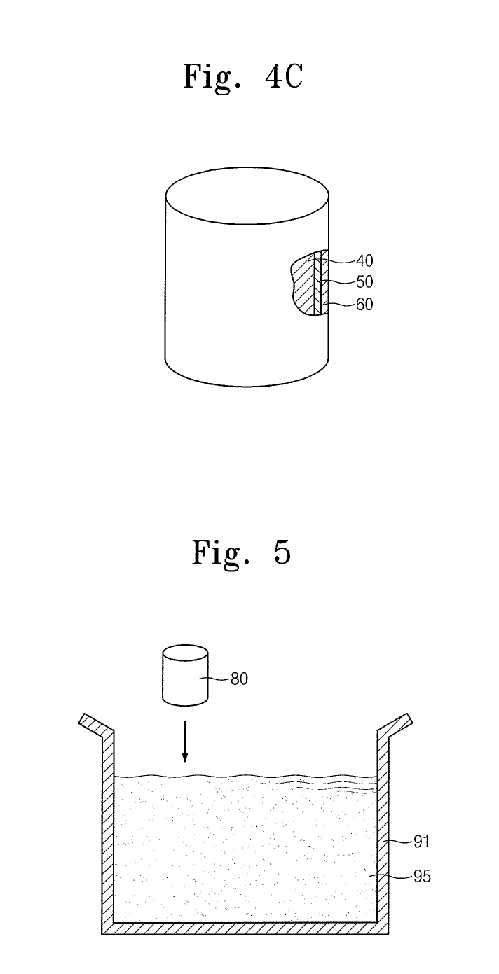

Then, the base conductor 40 formed with the first conductive layer 50 is immersed in the reaction solution including a solvent and metallic salt, thereby funning the second conductive layer 60 on the first conductive layer 50 (S40). Hereinafter, the method of forming the second conductive layer 60 will be described in detail with reference to FIG. 5.

FIG. 5 is a view showing the process of forming the second conductive layer 60 on the first conductive layer 50.

Referring to FIG. 5, a vessel 91 is filled with the reaction solution 95. The reaction solution 95 may include metallic salt and solvent. The metallic salt is a compound including, for example, one of beryllium (Be), magnesium (Mg), calcium (Ca), strontium (St), barium (Ba), cesium (Cs), and radium (Ra). For instance, the metallic salt may include, for example, cesium sulfate (CsSO₄).

The solvent may include, for example, one of alcohol including R—OH, ether including R—O—R′, benzene, benzene derivatives, and carboxylic acid including R—COOH, in which the R and R′ are alkyl groups having the carbon number of 15 or less.

If the reaction solution 95 includes CsSO₄ and ethanol, about 1 weight % to about 3 weight % of CsSO₄ may be contained in the reaction solution 95.

In general, the tendency of ethanol (C₂H₅OH) to generate OH— through ionization is much less than the tendency of water (H₂O) to generate OH— through ionization. For instance, when the base conductor 40 coated with the first conductive layer 50 including MgO is immersed in the reaction solution 95, magnesium ions MG2+, which are generated from the surface of the first conductive layer 50 through ionization of MgO, may rarely react with anions generated through ionization of the solvent.

However, different from the present exemplary embodiment, if the reaction solution 95 includes CsSO₄ and water, the water may generate OH— that readily reacts with metal cations, so that a great amount of OH— may exist in the reaction solution 95. In this case, if the base conductor 40 coated with the first conductive layer 50 including MgO is immersed in the reaction solution 95, magnesium ions may react with OH—, thereby forming MgOH₂ on the surface of the first conductive layer 40. The MgOH₂ is decomposed into MgO and water by heat generated during the operation of the lamp 100, so that the water may exist in the lamp 100, thereby degrading the luminous function of the lamp.

According to the present exemplary embodiment, the reaction solution 95 includes ethanol as a solvent, so that MgO that generates water in the lamp 100 may not be generated. Thus, the luminous function of the lamp 100 may not be degraded by the water generated through thermal decomposition of MgO.

Meanwhile, after coating the second conductive layer 60 on the base conductor 40, which is coated with the first conductive layer 50, the base conductor 40 coated with the first and second conductive layers 50 and 60 is subject to the heat treatment process at the temperature of about 100° C. to about 400° C. The remaining solvent is removed through the heat treatment process, so that the lamp electrode 80 is fabricated (S50). After that, the lamp electrode 80 is placed in the lamp body 5 (S60) and the reaction gas 30 is filled in the lamp body 5, thereby completing the fabrication of the lamp 100.

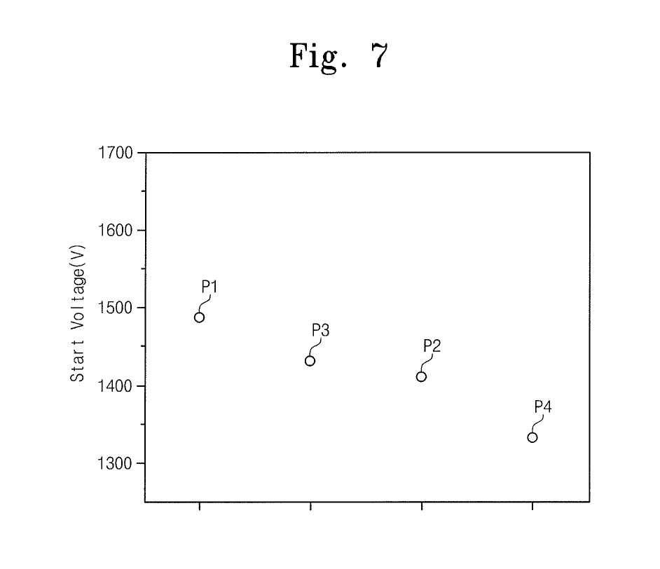

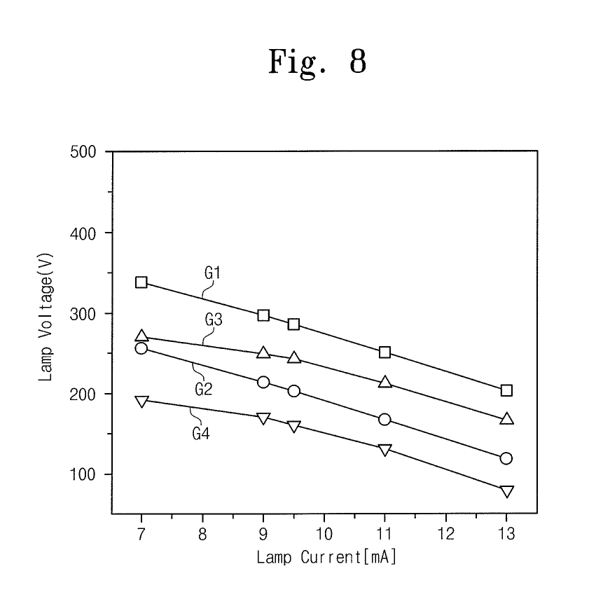

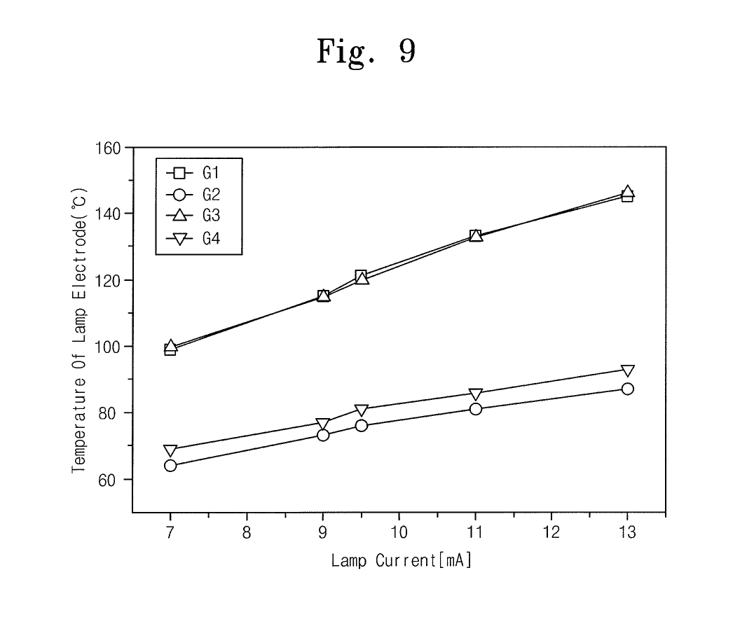

FIG. 7 is a graph showing the start voltage of the lamp 100 when the first conductive layer 50 is applied to the lamp electrode 80 or not, FIG. 8 is a graph showing the lamp voltage as a function of lamp current when the first conductive layer 50 is applied to the lamp electrode 80 or not, and FIG. 9 is a graph showing the temperature of a lamp electrode part as a function of lamp current when the first conductive layer 50 is applied to the lamp electrode 80 or not.

In the following description with respect to FIGS. 7 to 9, for the purpose of convenience, the first lamp will be defined as a lamp having a lamp electrode without the first conducive layer 50 with an internal pressure of about 30 Torr, the second lamp will be defined as a lamp having a lamp electrode without the first conducive layer 50 with an internal pressure of about 20 Torr, the third lamp will be defined as a lamp having a lamp electrode including the first conducive layer 50 with an internal pressure of about 30 Torr, and the fourth lamp will be defined as a lamp having a lamp electrode including the first conducive layer 50 with an internal pressure of about 20 Torr. The first to fourth lamps have the same length and diameter.

Referring to FIG. 7, a first point P1 represents the start voltage of the first lamp, and a third point P3 represents the start voltage of the third lamp. When measuring the first and third points P1 and P3, the start voltage of the first lamp is about 1480V, and the start voltage of the third lamp is about 1430V. That is, the start voltage can be reduced by applying the first conductive layer 50 to the lamp electrode 80 even though the first and third lamps have the same length, diameter and internal pressure.

In addition, a second point P2 represents the start voltage of the second lamp, and a fourth point P4 represents the start voltage of the fourth lamp. When measuring the second and fourth points P2 and P4, the start voltage of the second lamp is about 1420V, and the start voltage of the fourth lamp is about 1330V. In general, the start voltage of the lamp becomes reduced as the internal voltage of the lamp is reduced. In addition, similar to the first and third lamps, the start voltage of the lamp can be reduced by applying the first conductive layer 50 to the lamp electrode 80 even though the second and fourth lamps have the same length, diameter and internal pressure.

Referring to FIG. 8, first to fourth graphs G1 to G4 show the lamp voltage as a function of the lamp current. The first to fourth graphs G1 to G4 correspond to the first to fourth lamps, respectively. The lamp voltage refers to the internal voltage of the lamp, which allows the lamp to continuously emit the light.

Referring to the first and third graphs G1 and G3, the lamp voltage of the first lamp is higher than the lamp voltage of the third lamp. Thus, as the lamp voltage of the third lamp required to generate light having predetermined brightness is lower than the lamp voltage of the first lamp, power consumption of the first lamp is smaller than that of the third lamp.

Similar to the first and third graphs G1 and G3, referring to the second and fourth graphs G2 and G4, power consumption of the second first lamp required to generate light having predetermined brightness is smaller than that of the fourth lamp. Thus, power consumption required to drive the lamp can be reduced by applying the first conductive layer 50 to the lamp electrode.

Referring to FIG. 9, first to fourth graphs G1 to G4 show the temperature of the lamp electrode as a function of the lamp current. The first to fourth graphs G1 to G4 correspond to the first to fourth lamps, respectively.

Referring to the first to fourth graphs G1 to G4, the temperature of the lamp electrodes of the second and fourth lamps is lower than the temperature of the lamp electrodes of the first and third lamps by about 30° C. to about 60° C. even if the same current is applied to the first to fourth lamps. Therefore, similar to the second and fourth lamps, the temperature of the lamp electrode of the lamp can be reduced by coating the first conductive layer 50 on the base conductor 40. As a result, the temperature of the LCD having the lamp as a light source can be reduced and a mold frame used to fix the lamp to the LCD can be prevented from being deformed by heat generated from the lamp electrode.

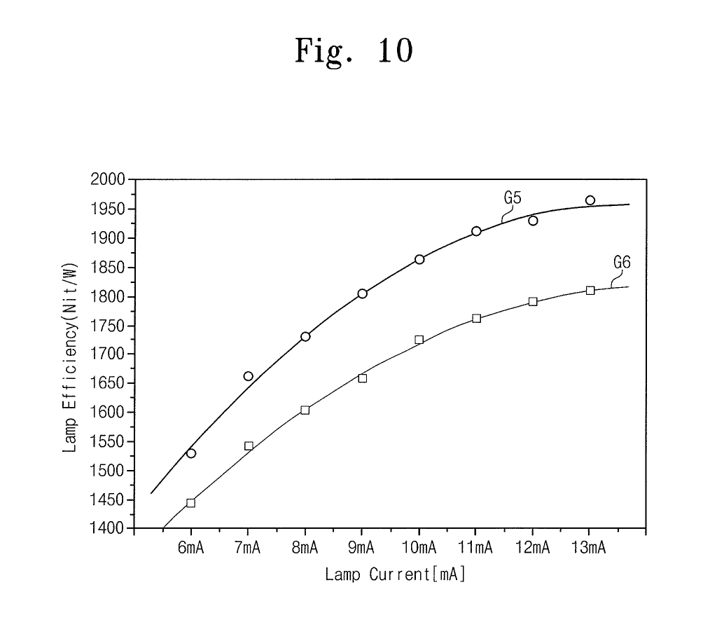

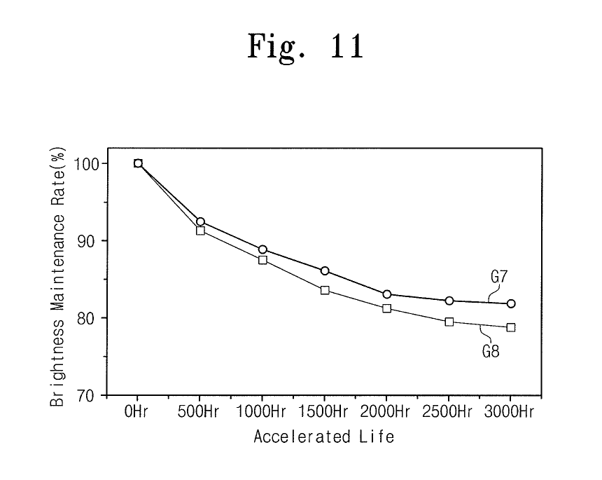

FIG. 10 is a graph showing lamp efficiency as a function of the lamp current when the first conductive layer 50 is applied to the lamp electrode 80 or not, and FIG. 11 is a graph showing a brightness maintenance rate as a function of accelerated life when the first conductive layer 50 is applied to the lamp electrode 80 or not. The lamp efficiency is defined as a value obtained by dividing brightness (Nit) of the lamp by power (Watt) applied to the lamp. The accelerated life refers to the virtual life of the lamp, which is set for a test, and is significantly shorter than the actual life of the lamp.

In the following description with respect to FIGS. 10 and 11, for the purpose of convenience, a fifth lamp refers to the lamp 100 according to the exemplary embodiment of the present invention and a sixth lamp refers to the lamp having the lamp electrode without the first conductive layer 50.

Referring to FIG. 10, a fifth graph shows the lamp efficiency as a function of the lamp current of the fifth lamp, and a sixth graph shows the lamp efficiency as a function of the lamp current of the sixth lamp.

Referring to the fifth and sixth graphs G5 and G6, the lamp efficiency of the fifth lamp is higher than the lamp efficiency of the sixth lamp by about 7% even if the same current is applied to the fifth and sixth lamps. In other words, if the first conductive layer 50 is applied to the lamp electrode 80, the amount of electrons emitted from the lamp electrode 80 may be increased due to the first conductive layer 50 including the metal having a low work function, so that the luminous efficiency of the lamp may be improved.

Referring to FIG. 11, a seventh graph G7 shows the brightness maintenance rate of the lamp as a function of the accelerated life of the fifth lamp, and an eighth graph G8 shows the brightness maintenance rate of the lamp as a function of the accelerated life of the sixth lamp.

Referring to the seventh and eighth graphs G7 and G8, the accelerated life of the fifth lamp maintained with predetermined brightness is longer than the accelerated life of the sixth lamp maintained with predetermined brightness. For instance, the accelerated life of the fifth lamp maintained with a brightness of about 83% is about 2000 hours as shown in the seventh graph G7, and the accelerated life of the sixth lamp maintained with a brightness of about 83% is about 2500 hours as shown in the eighth graph G8.

The accelerated life of the lamp can be lengthened by applying the first conductive layer 50 to the lamp electrode 80 because the first conductive layer 50 can protect the base conductor 40 from active ions existing in the lamp body 5. Thus, according to the exemplary embodiment of the present invention, as the first conductive layer 50 is applied to the lamp electrode 80, the accelerated life of the lamp can be lengthened, thereby extending the actual life span of the lamp.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A method of manufacturing a lamp, the method comprising:
preparing a lamp body provided therein with a discharge space and a fluorescent material;
forming lamp electrodes that emit electrons toward the discharge space by using a voltage supplied externally; and
arranging the lamp electrodes in the lamp body, wherein
the forming of each of the lamp electrodes comprises:
forming a base conductor;
forming a first conductive layer on the base conductor; and
reacting the first conductive layer with a reaction solution comprising a solvent and metallic salt to form a second conductive layer on the first conductive layer, and wherein
the solvent comprises one of an alcohol comprising R—OH, an ether comprising R—O—R′, benzene, benzene derivatives, and a carboxylic acid comprising R—COOH.

2. The method of claim 1, wherein the base conductor comprises at least one selected from the group consisting of nickel (Ni), molybdenum (Mo), niobium (Nb), tantalum (Ta), titanium (Ti), vanadium (V), chrome (Cr), gold (Au), copper (Cu) and aluminum (Al).

3. The method of claim 1, wherein the first conductive layer comprises one selected from the group consisting of beryllium (Be), magnesium (Mg), calcium (Ca), strontium (St), barium (Ba), cesium (Cs) and radium (Ra), and an oxide thereof.

4. The method of claim 3, wherein the first conductive layer comprises magnesium oxide (MgO).

5. The method of claim 3, wherein the first conductive layer is deposited on the base conductor by performing one of E-beam evaporation, ion plating and sputtering.

6. The method of claim 5, wherein the first conductive layer is deposited on the base conductor by performing the E-beam evaporation in an oxygen atmosphere.

7. The method of claim 5, wherein a deposition thickness of the first conductive layer is about 1 μm to about 6 μm.

8. The method of claim 1, wherein the metallic salt comprises one selected from the group consisting of beryllium (Be), magnesium (Mg), calcium (Ca), strontium (St), barium (Ba), cesium (Cs), and radium (Ra).

9. The method of claim 8, wherein the second conductive layer comprises one selected from the group consisting of beryllium (Be), magnesium (Mg), calcium (Ca), strontium (St), barium (Ba), cesium (Cs), and radium (Ra).

10. The method of claim 8, wherein the metallic salt comprises cesium sulfate (CsSO₄).

11. The method of claim 8, wherein the solvent comprises ethanol.

12. The method of claim 11, wherein the metallic salt of the reaction solution is cesium sulfate (CsSO₄), and wherein CsSO₄ is contained in the reaction solution in an amount of about 1 weight % to about 3 weight %.

13. The method of claim 1, wherein the forming of the lamp electrodes further comprises removing the solvent from surfaces of the lamp electrodes by heat treating the lamp electrodes.

14. The method of claim 1, wherein the R and R′ are alkyl groups having a carbon number of 15 or less.

15. A method of manufacturing a lamp, the method comprising:
forming a lamp body which includes a glass tube having a discharge space therein and fluorescent members provided on an inner wall of the lamp body;
forming lamp electrodes for arranging in the lamp body, wherein
the forming of each of the lamp electrodes comprises:
forming a base conductor;
depositing a first conductive layer having a thickness of about 1 μm to about 6 μm on the base conductor through one of E-beam evaporation, ion plating and sputtering, wherein the first conductive layer includes a metal having a high melting point such that the first conductive layer is not deformed by heat generated during operation of the lamp and has a low work function;
immersing the base conductor with the first conductive layer formed thereon in a reaction solution comprising a solvent and a metallic salt, thereby reacting the first conductive layer with the reaction solution to form a second conductive layer on the first conductive layer, wherein the second conductive layer comprises one of beryllium (Be), magnesium (Mg), calcium (Ca), strontium (St), barium (Ba), cesium (Cs), and radium (Ra), and wherein
the solvent comprises one of an alcohol comprising R—OH, an ether comprising R—O—R′, benzene, benzene derivatives, and a carboxylic acid, in which the R and R′ are alkyl groups having a carbon number of 15 or less;
removing the solvent by subjecting the base conductor, the first conductive layer and the second conductive layer to a heat treatment performed at a temperature of about 100° C. to about 400° C., thereby forming the lamp electrode;
arranging the lamp electrodes in the lamp body in the vicinity of both ends of the lamp body; and
filling in the lamp body with a reaction gas and sealing the lamp body, thereby completing fabrication of the lamp, and
wherein the lamp electrodes are electrically connected to lead terminals of the lamp such that power supplied externally is transferred to the lamp electrodes through the lead terminals, so that the lamp may emit light.

16. The method of claim 15, wherein the reaction gas is selected from the group consisting of mercury (Hg), neon (Ne), krypton (Kr), argon (Ar) and xenon (Xe).

17. The method of claim 15, wherein the base conductor is cylindrically shaped and wherein the cylindrically shaped base conductor comprises at least one selected from the group consisting of nickel (Ni), molybdenum (Mo), niobium (Nb), tantalum (Ta), titanium (Ti), vanadium (V), chrome (Cr), gold (Au), copper (Cu) and aluminum (Al).

18. The method of claim 15, wherein the metallic salt comprises one selected from the group consisting of beryllium (Be), magnesium (Mg), calcium (Ca), strontium (St), barium (Ba), cesium (Cs), and radium (Ra).

19. The method of claim 18, wherein the metallic salt is cesium sulfate (CsSO₄) and the solvent of the reaction solution is ethanol and wherein the cesium sulfate is contained in amount of about 1 weight % to about 3 weight % in the reaction solution.

20. The method of claim 15, wherein the first conductive layer is formed on the base conductor through the E-beam evaporation by loading a target metal and the base conductor in a chamber of an E-beam evaporator such that the target metal faces the base conductor, and the E-beam is irridated onto the target metal such that metal particles are generated from the target metal, thereby depositing the metal particles on the base conductor, and wherein a deposition direction of the metal particles deposited on the base conductor is slightly tilted at an angle of about 45° or below.
